(19) United States
(12) Patent Application Publication
(10) Pub. No.: US 2009/0286149 A1
(43) Pub. Date: Nov. 19, 2009

(54) ADAPTIVE RECONFIGURABLE BATTERY

(75) Inventors: SONG CI, Omaha, NE (US); Mahmoud Alahmad, Omaha, NE (US); Hamid Sharif-Kashani, Omaha, NE (US)

Correspondence Address: FISH & RICHARDSON P.C., PO BOX 1022, MINNEAPOLIS, MN, 55440-1022, US

(73) Assignee: Board of Regents of the University of Nebraska, Lincoln, NC (US)

(21) Appl. No.: 12/119,958

(22) Filed: May 13, 2008

(51) Int. Cl. H01M 6/42

(52) U.S. Cl. 429/160

(57) ABSTRACT

Embodiments of the present invention relate to methods and apparatus for a dynamic reconfigurable battery system for supporting power-aware computing. The present invention allows each cell of a multi-cell battery to be charged and/or discharged separately depending on an external load that is applied to the system. The present invention, the dynamic reconfigurable multi-cell battery system, may support dynamic voltage scaling (DVS) by providing fine-tuned voltage levels to satisfy the various power requirements imposed by different system components. Another embodiment of the present invention includes taking advantage of power requirement diversity in a power-aware computing platform to fully utilize a battery's capacity. Also, this system is adaptable to isolate fully discharged or failed cells from other functioning cells. The dynamic reconfigurable design of the present invention provides a solution for an emergent power supply for mission-critical tasks.

### TECHNICAL FIELD

The invention relates generally to methods and apparatus for configuring a battery and, more particularly, to methods and apparatus for adapting and reconfiguring a battery.

### BACKGROUND OF THE INVENTION

Battery operation time per charge are among the most important performance parameters for today's networked embedded systems such as wireless sensors, active radio frequency identification (RFID) tags, personal digital assistants (PDAs), cellular or mobile telephones, and other battery powered devices. In some critical mission scenarios such as emergency rescue, law enforcement, fire fighting, and the battlefield, an optimal battery operation time could save more lives. Furthermore, each year millions of various depleted rechargeable batteries are discarded, causing not only a high cost to dispose of these batteries but also an environmental issue to consider. As such, it is beneficial to improve both battery operation time and a battery's lifespan.

### SUMMARY OF THE INVENTION

Embodiments of the present invention relate to methods and apparatus for a dynamic reconfigurable battery system for supporting power-aware computing. The present invention allows each cell of a multi-cell battery to be charged and/or discharged separately. The present invention permits a battery's capacity to be fully utilized by, for example, taking advantage of power requirement diversity in a power-aware computing platform. The present invention, the dynamic reconfigurable multi-cell battery system, may support dynamic voltage scaling (DVS) by providing fine-tuned voltage levels to satisfy the various power requirements imposed by different system components. Also, this system is adaptable to isolate fully discharged or failed cells from other functioning cells. The dynamic reconfigurable design of the present invention provides a solution for an emergent power supply for mission-critical tasks.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE SEVERAL VIEWS OF THE DRAWINGS

Embodiments are described in detail below with reference to the attached drawing figures, wherein:

FIG. 1 is an illustration of one embodiment of an adaptively configurable battery system with one set of positive and negative terminals;

FIG. 2 is an illustration of one embodiment of an adaptively configurable battery system one two sets of positive and negative terminals;

FIG. 3 is an illustration of one embodiment of an adaptively configure battery system where one of the plurality cells has failed; and

FIG. 4 is an flow diagram illustrating an exemplary method for configuring the battery system.

### DETAILED DESCRIPTION OF THE INVENTION

The subject matter of embodiments of the present invention is described with specificity herein to meet statutory requirements. However, the description itself is not intended to limit the scope of this patent. Rather, the inventors have contemplated that the claimed subject matter might also be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

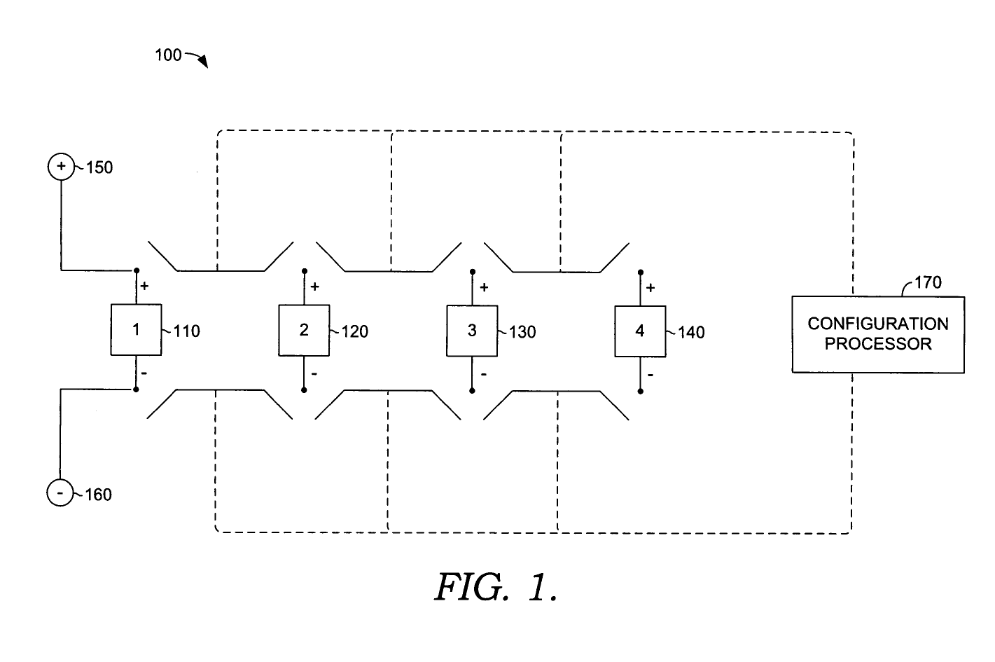

Referring to the drawings in general, and initially to FIG. 1 in particular, an exemplary adaptively, configurable battery system is shown and designated generally as system 110. System 110 is but one example of a suitable computing environment and is not intended to suggest any limitation as to the scope of use or functionality of the invention. Neither should system 110 be interpreted as having any dependency or requirement relating to any one or combination of components illustrated.

The battery 100 includes a plurality of battery cells and a set of positive and negative terminals. In FIG. 1, four battery cells are illustrated to keep the figure and description as clear as possible. The present invention is not limited to four cells but may include a plurality of battery cells. Each battery cell 110, 120, 130, 140 has a positive terminal and a negative terminal. The positive and negative terminals are configured to produce a voltage differential between the two terminals. A pair of battery cells such as 110 and 120, can be connected through the positive and negative terminals. A pair of battery connections are configured to receive an applied load external to the multi-cell battery system.

With the multiple cells within the battery system, multiple cells can produce a connection between each other. These connections are fully adaptable depending on the external load applied to the battery system. The connections are configured to selectively form an electrical connection between the positive connection of the pair of battery connection and the positive terminal of at least one of the battery cells. The connections are also configured to selectively form an electrical connection between the negative connection of the pair of battery connection and the negative terminal of at least one of the battery cells.

A configuration processor 170 senses the external load that is applied to the multi-cell battery system. The processor 170 adapts the plurality of adaptable connections between the terminals of the individual battery cells and the pair of battery connections. The processor 170 controls the connections through the dotted lines illustrated in FIG. 1. The processor accommodates the applied external load depending whether the load requires the battery to charge or discharge.

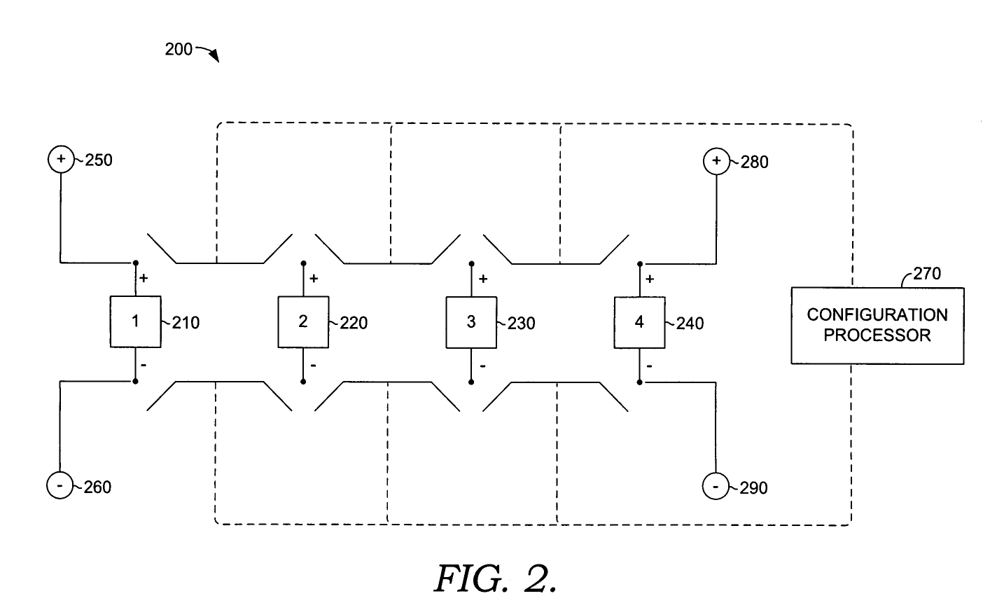

The battery 200 illustrated in FIG. 2 is similar to the battery 100 illustrated in FIG. 1 but it illustrates another embodiment of the present invention. The battery 200 illustrates four battery cells but is not limited to that. The battery 200 in FIG. 2 illustrates a system including two separate sets of positive and negative terminals (250, 260 and 280, 290). This system may provide benefits when used with systems that use multiple different voltages. For example, a system requires two small separate voltages, the battery 200 can configure the connections between the different cells to provide two separate voltages at the two separate sets of positive and negative terminals (250, 260 and 280, 290). The configuration processor 270 may sense the differing loads on the separate terminals and then configure the terminals of the battery cells to meet the demands of each load. The system 200 illustrated here would be able to accommodate that situation described above with this adaptively configurable battery.

The present invention, as illustrated in both FIG. 1 and FIG. 2, provides the ability to dynamically configure the connections of the battery cells in a series, parallel, or a mixture of series-parallel configuration. According to the definition of the series circuit, the output currents of a series connected battery cells are the same. However, the output voltages are independent meaning if n battery cells are connected in series together and the current of each battery cell is i₁, i₂, iₙ, then

i₁=i₂=iₙ=I (1)

Based on these parameters, the Remaining Capacity (RC) of this configuration is

$${RC}_{series} ( {i}_{i} , {i}_{2} , … {i}_{n} , {v}_{1} , {v}_{2} , … , {v}_{n} ) = {\sum }_{j = 1}^{n} {RC}_{j} ( {i}_{j} , {v}_{j}^{′} ) \qquad ( 2 )$$

Here, v′ⱼ can be obtained from Equation (3), and each RCⱼ (iⱼ, vⱼ) can be derived, based on the required voltage and discharge current, from the model in An Analytical Model for Predicting the Remaining Battery Capacity of Lithium-Ion Batteries by Rong Peng, Massoud Pedram; IEEE TRANSACTIONS ON VERY LARGE SCALE INTEGRATION (VLSI) SYSTEMS, VOL. 14, NO. 5, MAY 2006. If the terminal voltages (v₁ⱼ and v₂ⱼ) are known for different currents i₁ⱼ and i₂ⱼ, then the output voltage vⱼ of each battery cell with the discharge current i at time t can be calculated as

$$\begin{matrix}{v}_{j}^{′} = \frac{{v}_{2 j} - {v}_{1 j}}{{i}_{2 j} - {i}_{1 j}} i + {v}_{2 j} & ( 3 ) \\ {RC}_{j} ( {i}_{j} , {v}_{j} ) = \{ \frac{1 - exp ( \frac{{r}_{nj} \cdot I - ( {v}_{ini} - {v}_{cutoff} )}{λ} )}{{b}_{1 j}} \} \frac{1}{{b}_{2 j}} - \{ \frac{1 - exp ( \frac{{r}_{nj} \cdot I - ( {v}_{ini} - {v}_{j}^{′} )}{λ}}{{b}_{1 j}} \} \frac{1}{{b}_{2 j}} & ( 4 )\end{matrix}$$

where:

Vᵢₙᵢ is the initial voltage

V_{cutoff} is the cutoff voltage

For a parallel configuration, the output voltages across the parallel connected battery cells are the same, however, their output current is independent. For example, if n batteries are connected in parallel, and the voltage of each battery cell is v₁,v₂, vₙ, then

v₁=v₂==vₙ=vₚₐᵣₐₗₗₑₗ (5)

Therefore, the Remaining Capacity (RC) of this configuration is

$${RC}_{parallel} ( {i}_{1} , {i}_{2} , … {i}_{n} , {v}_{1} , {v}_{2} , … , {v}_{n} ) = {\sum }_{j = 1}^{n} {RC}_{j} ( {i}_{j} , {v}_{j}^{′} ) \qquad ( 6 )$$

Where, v′ⱼ can be obtained by equation (3). If the required current of user is i, then

I=i₁+i₂++iₙ (7)

If we know the terminal voltages v₁ₚ and v₂ₚ, for different currents i₁ₚ and i₂ₚ, and the output of the parallel connected battery cells is vₚₐᵣₐₗₗₑₗ, then the terminal voltage at current i at time t can be calculated as

$$\begin{matrix}i = \frac{{i}_{2 p} - {i}_{1 p}}{{v}_{1 p} - {v}_{2 p}} {v}_{parallel} & ( 8 ) \\ {RC}_{parallel} ( {i}_{1} , {i}_{2} , … , {i}_{n} , {v}_{1} , {v}_{2} , … {v}_{n} ) = {\sum }_{j = 1}^{n} {RC}_{j} ( {i}_{j} , {v}_{j} ) & ( 9 )\end{matrix}$$

For a series-parallel connected configuration in a multi-cell battery, n*m cells can be connected in a series-parallel configuration. The i₁₁=i₂₂==iₙₘ, can be obtained through equation (9). The remaining capacity is

$${RC}_{s - p} ( {i}_{11} , {i}_{12} , … , {i}_{n m} , {v}_{11} , {v}_{12} , … , {v}_{n m} ) = {\sum }_{i = 1}^{n} {\sum }_{j = 1}^{m} {RC}_{ij} ( {i}_{ij} , {v}_{ij}^{′} ) \qquad ( 10 )$$

where v′ᵢⱼ can be obtained by equation (3). Therefore, all kinds of connections can be calculated by equations (2), (6), and (10) when p battery cells are series connected with n*m series-paralleled connected battery cells, and the required discharge current is i, then the remaining capacity RCₛ₋ₛ₋ₚ of the p+m battery system is

$$\begin{matrix}{RC}_{s , s - p} = {RC}_{s - p} ( {i}_{11} , {i}_{12} , … , {i}_{n m} , {v}_{11} , {v}_{12} , … , {v}_{n m} ) + \\ {RC}_{series} ( {i}_{1} , {i}_{2} , … , {i}_{n} , {v}_{1} , {v}_{2} , … , {v}_{n} ) \\ = {\sum }_{i = 1}^{n} {\sum }_{j = 1}^{m} {RC}_{ij} ( {i}_{ij} , {v}_{ij}^{′} ) + {\sum }_{k = 1}^{p} {RC}_{k} ( {i}_{k} , {v}_{k}^{′} ) \\ = {\sum }_{i = 1}^{n} m * RC ( \frac{i}{m} , {v}_{i} ) + {\sum }_{k = 1}^{p} {RC}_{k} ( i , {v}_{k} )\end{matrix} \qquad ( 11 )$$

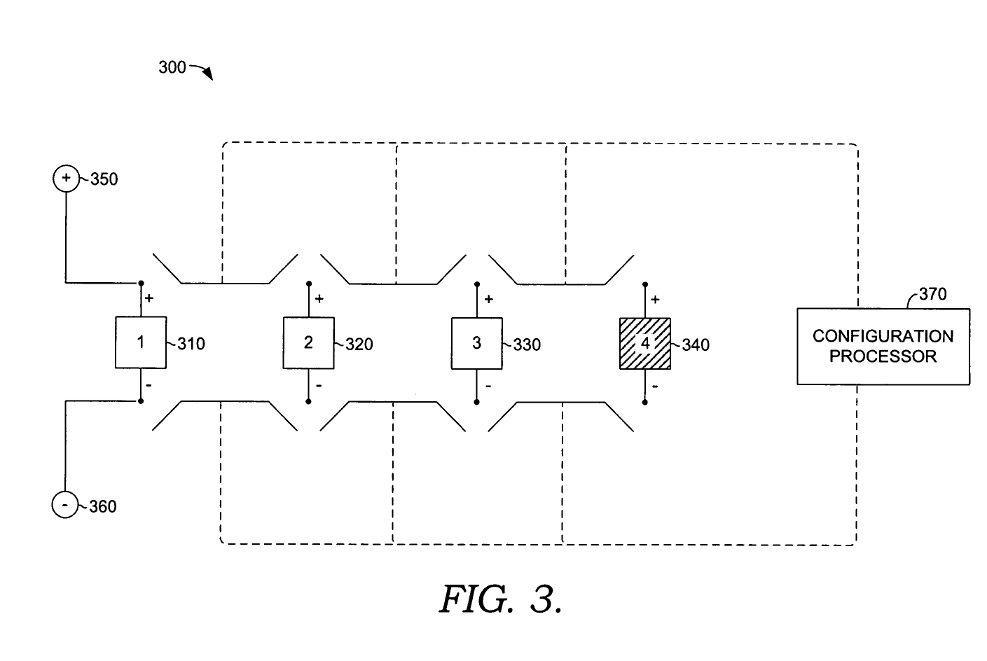

The battery 300 illustrated in FIG. 3 is similar to the battery 100 illustrated in FIG. 1 but one of the battery cells has failed. Battery cell 4 shows a different appearance than the rest of the battery cells in the battery system 300. This difference is to illustrate that battery cell 4 has stopped functioning in some manner. How or why battery cell 4 has stopped functioning is irrelevant. The embodiment illustrated in FIG. 3 demonstrates that the present invention will continue functioning even though a dead or failed cell is encountered. It should also be noted that this scenario is not limited to only battery cell 4 failing but any one of the cells could fail or a combination of cells. The present invention detects a failed cell and removes it from the connections. Also as in the previous embodiments, the present invention may include any number of battery cells.

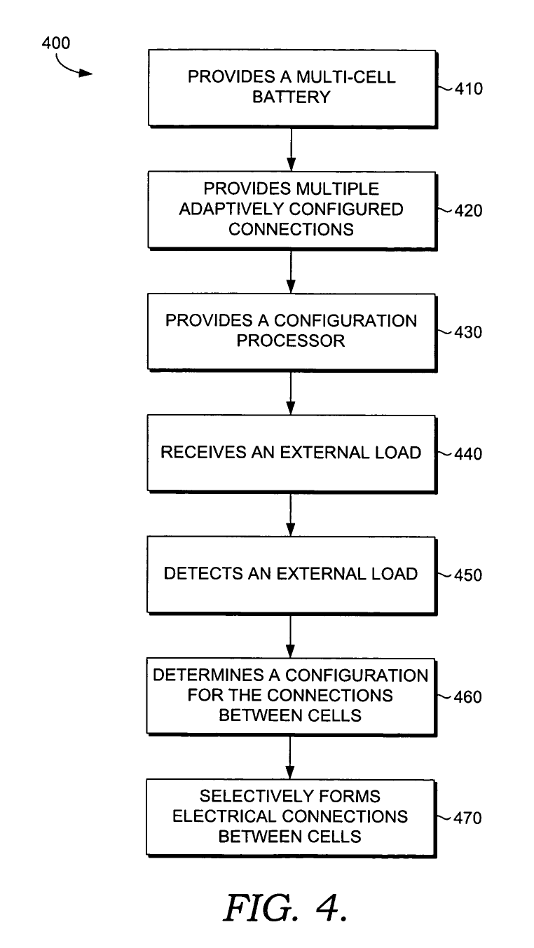

In FIG. 4, an exemplary method for configuring the battery is illustrated. Initially, a multi-cell battery is provided (410) such as the ones illustrated in FIG. 1 and FIG. 2. Within the multi-cell battery includes a plurality of adaptive connections (420) to provide a voltage difference between the battery cells. Also, a configuration processor is provided (430) to optimally configure the connections between the cells based on an external load. A configuration processor may be a microprocessor, or the software stored on a microprocessor. An external load is applied (440) to the battery and the load is received by the battery's terminals described in FIG. 1 and FIG. 2. An external load can be any number of things that require power from a battery or charges a battery. Next, the configuration processor detects the applied load (450) and then determines the optimal connections between battery cells (460). Then the connections between the battery cells are selectively formed to produce an electrical connection (470).

It is to be understood that the specific embodiments of the present invention that are described herein are merely illustrative of certain applications of the principles of the present invention. It will be appreciated that, although an exemplary embodiment of the present invention has been described in detail for purposes of illustration, various modifications may be made without departing from the spirit and scope of the invention. Therefore, the invention is not to be limited except as by the appended claims.

What is claimed is:

1. A multi-cell battery comprising:
a plurality of battery cells, each battery cell having a positive terminal and a negative terminal and configured to produce a voltage differential between its positive terminal and its negative terminal;
a pair of battery connections comprising a positive connection and a negative connection, the pair of battery connections being configured to receive an applied electrical load external to the multi-cell battery;
a plurality of adaptable connections, the plurality of adaptable connections being configured to selectively form an electrical connection between the positive connection of the pair of battery connection and the positive terminal of at least one of the plurality of battery cells, the plurality of adaptable connections being further configured to selectively form an electrical connection between the negative connection of the pair of battery connections and the negative terminal of at least one of the plurality of battery cells; and
a configuration processor that senses an external load applied to the multi-cell battery received by the pair of battery connections and adapts the plurality of adaptable connections between the terminals of the plurality of battery cells and the pair of battery connections to optimally accommodate the applied electrical load, whether the applied electrical load causes the battery cells adaptably connected to the pair of battery connections to charge or discharge.

2. The multi-cell battery of claim 1 further comprising:
the plurality of adaptable connections being configured in a series configuration.

3. The multi-cell battery of claim 1 further comprising:
the plurality of adaptable connections being configured in a parallel configuration.

4. The multi-cell battery of claim 1 further comprising:
the plurality of adaptable connections being configured in a series-parallel configuration.

5. A method claim comprising:
providing a multi-cell battery having a plurality of battery cells, each battery cell having a positive terminal and a negative terminal and configured to produce a voltage difference between its positive and its negative terminal;
providing a pair of battery connections between the plurality of battery cells comprising a positive connection and a negative connection wherein the battery connections are adaptively configurable;
providing a configuration processor that is operable to detect an applied external load and configure the plurality of battery connections;
sensing the applied external load;
determining an optimal configuration for the battery connections to accommodate the applied external load; and
selectively form electrical connections between the battery cells to charge or discharge the multi-cell battery.

6. The method of claim 5 further comprising:
the optimal configuration for the battery connections configured in a series configuration.

7. The method of claim 5 further comprising:
the optimal configuration for the battery connections configured in a parallel configuration.

8. The method of claim 5 further comprising:
the optimal configuration for the battery connections configured in a series-parallel configuration.
